(19) United States
(12) Patent Application Publication
(10) Pub. No.: US 2023/0063456 A1
(43) Pub. Date: Mar. 2, 2023

(54) DETECTION METHOD AND DETECTION DEVICE OF WAFER TESTING MACHINE

(71) Applicant: CHANGXIN MEMORY TECHNOLOGIES, INC., Hefei City, Anhui (CN)

(72) Inventor: Shisheng WANG, Hefei City, Anhui (CN)

(21) Appl. No.: 17/603,485

(22) PCT Filed: Jul. 20, 2021
(86) PCT No.: PCT/CN2021/107441

§ 371 Date: Oct. 13, 2021

(30) Foreign Application Priority Data
Nov. 10, 2020 (CN) 202011245602.5

(51) Int. Cl. G06F 11/22

(52) U.S. Cl. CPC G06F 11/2247

(57) ABSTRACT

The present disclosure provides a detection method and a detection device of a wafer testing machine, the detection method includes: storing an original test data tested by multiple wafer testing machines into a database; sifting out target test data from the original test data according to preset sifting conditions; performing statistics on the target test data sifted; and dividing the multiple wafer testing machines into comparison machines and machines to-be-detected; comparing whether there is significant difference between a target test data of each of the machine to-be-detected and a target test data of the comparison machine, in a corresponding test item within a first predetermined number of days; and performing statistics on number of days when each of the machines to-be-detected has significant difference; marking each of the machines to-be-detected, according to a statistical number of days when each machine to-be-detected has a significant difference.

### CROSS-REFERENCE TO RELATED APPLICATIONS

The present disclosure is a national stage of International Patent Application No. PCT/CN2021/107441, filed on Jul. 20, 2021, which claims the priority to Chinese Patent Application No. 202011245602.5, titled “DETECTION METHOD AND DETECTION DEVICE OF WAFER TESTING MACHINE”, filed to China National Intellectual Property Administration on Nov. 10, 2020. The entire contents of International Patent Application No. PCT/CN2021/107441 and Chinese Patent Application No. 202011245602.5 are incorporated herein by reference.

### TECHNICAL FIELD

The present disclosure relates to, but is not limited to, a detection method and a detection device of a wafer testing machine.

### BACKGROUND

After the wafer production is completed, the wafer is randomly assigned to different testing machines for Circuit Probing (CP; wafer test) and Final Test (FT; finished product test), and record all the parameters of each wafer in the CP and FT. By making statistics on the recorded parameter values, abnormal testing machines can be detected, helping engineers to check and maintain the corresponding testing machines.

At present, the detection process of abnormal wafer testing machine takes a long time and the detection accuracy is low.

### SUMMARY

The following is the summary of subject matters detailed in the present disclosure. The summary is not intended to limit the protection scope of the claims.

The present disclosure provides a detection method and a detection device of a wafer testing machine.

A first aspect of the present disclosure provides the detection method of the wafer testing machine, the detection method comprises:

storing an original test data of a same batch of wafers tested by multiple wafer testing machines in multiple test items into a database;

sifting out target test data from the original test data in the database according to preset sifting conditions;

performing statistics on the target test data sifted; and dividing the multiple wafer testing machines into comparison machines and machines to-be-detected in each of the test items;

comparing whether there is significant difference between a target test data of each of the machine to-be-detected and a target test data of the comparison machine, in a corresponding test item within the first predetermined number of days; and performing statistics on number of days when each of the machines to-be-detected has significant difference;

marking each of the machines to-be-detected, according to a statistical number of days when each machine to-be-detected has a significant difference.

A second aspect of the present disclosure provides a detection device of wafer testing machine, the detection device comprises:

a storage unit, configured to store an original test data of a same batch of wafers tested by multiple wafer testing machines in multiple test items into a database;

a sifting unit, configured to screen out target test data from the original test data in the database according to preset sifting conditions;

a distinguishing unit, configured to perform statistics on the target test data sifted, to divide the multiple wafer testing machines into comparison machines and machines to-be-detected in each of the test items;

a comparing unit, configured to compare whether there is a significant difference between a target test data of each machine to-be-detected and a target test data of the comparison machine, in a corresponding test item within the first predetermined number of days, and to perform statistics on number of days when each of the machine to-be-detected has significant difference;

a marking unit, configured to mark each of the machines to-be-detected according to a statistical number of days when each machine to-be-detected has a significant difference.

### BRIEF DESCRIPTION OF THE DRAWINGS

The drawings incorporated into the specification and constituting a part of the specification illustrate the embodiments of the present disclosure, and together with the description to explain the principles of the embodiments of the present disclosure. In these drawings, similar reference numerals are used to indicate similar elements. The drawings in the following description are some embodiments of the present disclosure, but not all embodiments. For those skilled in the art, other drawings can be obtained based on these drawings without any creative efforts.

FIG. 1 is a schematic flowchart of a detection method of a wafer tester according to an embodiment of the present disclosure.

FIG. 2 is a schematic diagram of a box plot of the multiple wafer testing machines according to an embodiment of the present disclosure.

FIG. 3 is a schematic diagram of the upper quartile and the lower quartile of the stable group according to the embodiment of the present disclosure.

### DETAILED DESCRIPTION

The technical solutions of the embodiments of the present disclosure clearly and completely described below with reference to the accompanying drawings in the embodiments of the present disclosure. Obviously, the described embodiments are a part of the embodiments of the present disclosure, not all the embodiments. Based on the embodiments in the present disclosure, all other embodiments obtained by those skilled in the art without any creative efforts shall fall within the protection scope of the present disclosure. It should be noted that the embodiments in the present disclosure and the features in the embodiments can be combined with each other arbitrarily if there is no conflict.

In related technologies, the wafer testing machine can perform CP and FT on wafers, and record all the parameters of each wafer in the CP and FT. By counting the recorded parameter values, abnormal testing machines can be detected, which helps engineers to inspect and maintain the corresponding testing machines. Because the amount of data produced by a testing machine after testing a wafer is massive, engineers usually store the data in a database.

At present, engineers manually and randomly select the data from the database, and perform simple statistical operations on the sifted data to determine whether there are differences in the yield of multiple test items for the same batch of wafers on different testing machines, and then identify abnormal testing machines according to the difference in yield.

However, this method has the following disadvantages: \textcircled{1} The timeliness is low, and cannot automatically detect the abnormal testing machine in time, resulting in a long time to find the problem; \textcircled{2} The data are randomly selected and analyzed by manpower, which is complicated and time-consuming. \textcircled{3} The data used is not all data, which makes the data analysis results have errors, which leads to the low accuracy of the difference detection machine.

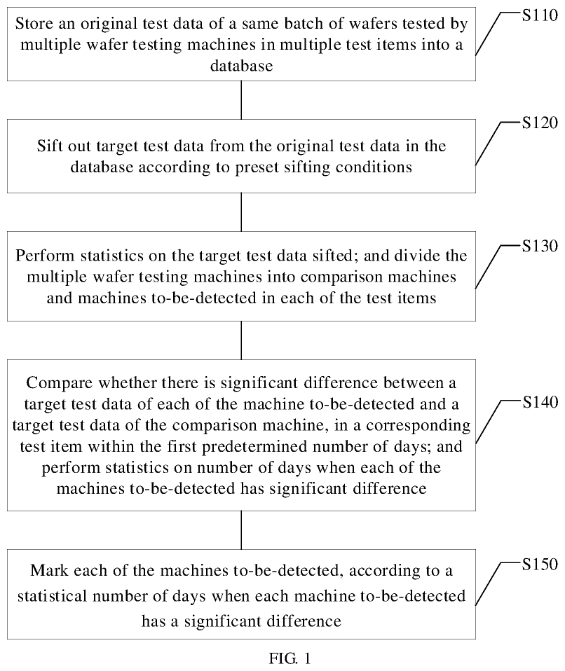

An embodiment of the present disclosure provides a detection method of a wafer testing machine. As shown in FIG. 1, the detection method of a wafer testing machine of the embodiment of the present disclosure may include:

Step S110, storing the original test data of the same batch of wafers tested by multiple wafer testing machines in multiple test items into the database;

Step S120, sifting out target test data from the original test data in the database according to preset sifting conditions;

Step S130, performing statistics on the sifted target test data; and dividing the multiple wafer testing machines into the comparison machines and the machines to-be-detected in each of the test items;

Step S140, comparing whether there is significant difference between the target test data of each of the machine to-be-detected and the target test data of the comparison machine, in a corresponding test item within the first predetermined number of days, and performing statistics on number of days when each of the machines to-be-detected has significant difference;

Step S150, marking each machine to-be-detected according to the statistical number of days when each machine to-be-detected has a significant difference.

The comparison machine is equivalent to the standard machine, that is, the comparison machine has no abnormal situation, and then the comparison machine is used as the standard to determine whether the machine to-be-detected has an abnormal situation. For example, if the target test data of the machine to-be-detected has a significant difference, it means that the machine to-be-detected has an abnormal risk; if the target test data of the machine to-be-detected does not have a significant difference, it means that the machine to-be-detected is operating well.

After performing statistics on the number of days when each machine to-be-detected has a significant difference, mark each machine to-be-detected according to the statistical number of days when each machine to-be-detected has a significant difference. Thus, according to the marking results of each machine to-be-detected, it can be judged which wafer testing machine has abnormal conditions.

Therefore, compared with the solutions of manually selecting data and manual statistics in the prior art, the detection method of the present disclosure can automatically sift data and automatically count, that is, the detection method can automatically complete the detection process of the wafer testing machine, thereby reducing the time consumption of the detection process.

Moreover, the detection method of the present disclosure sifts out the target test data from the original test data according to the preset sifting conditions, so that the number of target test data used for statistics is larger, thereby reducing the error of data analysis and improving the accuracy of the detection results of the wafer testing machine.

The detection method provided by the embodiments of the present disclosure will be described in detail below with reference to the accompanying drawings:

In step S110, storing the original test data of the same batch of wafers tested by multiple wafer testing machines in multiple test items into the database;

As mentioned above, the wafer testing machine can perform CP and FT on wafers, and record all the parameters of each wafer in the CP and FT. The parameter corresponding to the FT is temperature, and the parameter corresponding to the CP includes current, voltage, inductance, etc., which will not be described in detail here.

It should be noted that this disclosure assumes that the original test data of multiple test items for wafers produced in the same batch are the same. At the same time, each test parameter corresponds to a test item. Therefore, if the test data of the same batch of wafers tested by different wafer testing machines in multiple test items are different, it means that a certain wafer testing machine or several wafer testing machines have abnormal conditions.

In step S120, sifting out target test data from the original test data in the database according to preset sifting conditions.

Since the wafer testing machine can test multiple types of wafers and parameters in multiple production stages, the preset sifting conditions may include wafer types and production stages, etc., which will not be described in detail here. As mentioned above, the sifting process can be automatically carried out by the detection system of the wafer testing machine, so that the number of target test data for subsequent statistics is larger, thereby reducing the error of data analysis and improving the accuracy of the detection result.

In step S130, performing statistics on the sifted target test data, and dividing the multiple wafer testing machines into the comparison machines and the machines to-be-detected in each of the test items.

In an exemplary embodiment, step S130 may include:

Step S1301, sorting each wafer testing machine according to the median of the target test data of each wafer testing machine sifted, and taking 50% of the wafer testing machines in the middle as a stable group. In detail, sorting each wafer testing machine according to the median can include two steps:

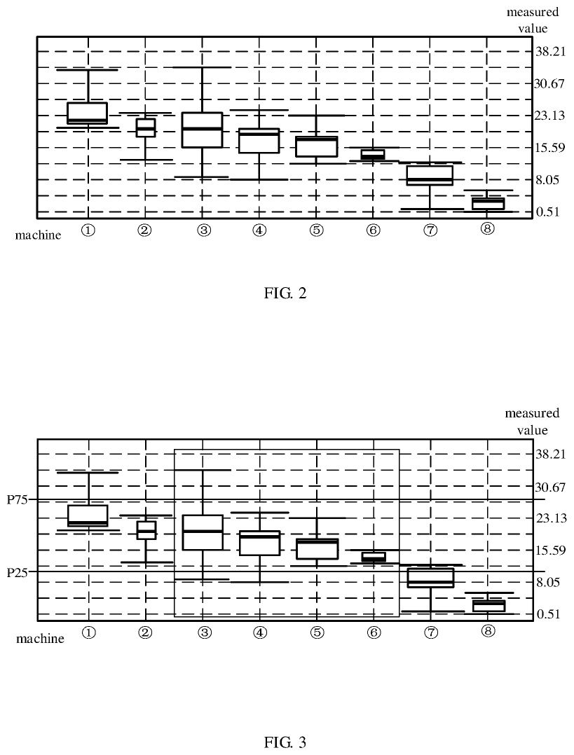

Step S13011, according to the sifted target test data of each wafer testing machine, drawing the box plot corresponding to each wafer testing machine (as shown in FIG. 2).

The box plot is a statistical plot used to display the distribution of data groups, which can reflect the characteristics of the original data distribution. At the same time, the box plot can also be used to compare the distribution characteristics of multiple sets of data. In the process of drawing the box plot, firstly find the upper edge, lower edge, median and two quartiles of a set of data; then connect the two quartiles to draw the box; finally connect the upper and lower edges with the box body to form a box plot of the data group. Of course, the median is located inside the box and will not be described in detail here.

Step S13012, sorting the medians in the box plots to complete the sorting of the wafer testing machines, and then taking 50% of the wafer testing machines in the middle as a stable group and circling it with a wire frame (as shown in FIG. 3).

Of course, the number of wafer testing machines is an even number to facilitate the selection of stable groups. As shown in FIG. 3, after selecting the stable group, divide the stable group into quarters to obtain the upper quartile P75 and the lower quartile P25 of the stable group, which will not be described in detail here.

Step S1302, according to the upper quartile P75 and the lower quartile P25 of the stable group, the multiple wafer testing machines are divided into the comparison machines and the machines to-be-detected in each test item.

For example, if the median of the box plot of a wafer testing machine is greater than the upper quartile P75, the wafer testing machine is a machine to-be-detected. If the median of the box plot of a wafer testing machine is greater than or equal to the lower quartile P25 and less than or equal to the upper quartile P75, the wafer testing machine is the comparison machine. If the median of the box plot of a wafer testing machine is less than the lower quartile P25, the wafer testing machine is a machine to-be-detected.

In other words, if the median of the wafer tester is within the interval composed of the lower quartile P25 and the upper quartile P75, then the wafer testing machine is a comparison machine, and accordingly, the wafer testing machines with other case are all machines to-be-detected.

Therefore, it can be seen from FIG. 3 that machine \textcircled{1}, machine \textcircled{2}, machine \textcircled{3}, machine \textcircled{4}, machine \textcircled{5} and machine \textcircled{6} are the comparison machines, while machine \textcircled{7} and machine \textcircled{8} are the machines to-be-detected, which will not be described in detail here.

In step S140, comparing whether there is significant difference between the target test data of each of the machine to-be-detected and the target test data of the comparison machine, in a corresponding test item within the first predetermined number of days, and performing statistics on the number of days when each of the machine to-be-detected has significant difference;

The first predetermined number of days may be 7 days, that is, a full cycle of one week is used to detect each wafer testing machine. Of course, the first predetermined number of days can also be 5 days, 6 days, 8 days, 9 days, etc., and there is no special limitation here.

For example, the t-test method can be used to compare whether there is a significant difference between the target test data of each machine to-be-detected and the target test data of the comparison machine within the first predetermined number of days. Of course, comparisons can also be made by methods such as f-test or chi-square test, and there is no special limitation here.

For example, if the target test data of the machine to-be-detected has a significant difference, it means that the machine to-be-detected has an abnormal risk; if the target test data of the machine to-be-detected does not have a significant difference, it means that the machine to-be-detected is operating well.

In an exemplary embodiment, the t-test method satisfies the first relation formula as follow:

$$\{ \begin{matrix}t = \frac{\overline{x} - {μ}_{0}}{\frac{S}{\sqrt{n}}} \\ v = n - 1\end{matrix} ;$$

wherein, x̅ is the average value of the target test data of the comparison machines; μ₀ is the average value of the target test data of the machines to-be-detected; v is the degree of freedom; n is the number of the target test data of the comparison machine; S is the standard deviation of each target test data of the comparison machines, and S satisfies the second relation formula as follow:

$$S = \sqrt{\frac{{\sum }_{i = 1}^{n} {( {x}_{i} - \overline{x} )}^{2}}{n}} ;$$

wherein, xᵢ is the target test data of the comparison machine in the first predetermined number of days.

The following examples give a detailed introduction to the judgment process of the t-test method:

Supposing that the machine to-be-detected tested three batches of wafers on the same day, and their measured values were 30, 32 and 40 respectively, while the comparison machine tested ten batches of wafers on the same day, and their measured values were 10, 11, 10, 13, 15, 25, 9, 12, 10 and 8 respectively. Combining the first relation formula and the second relation formula, we can know:

$$\{ \begin{matrix}t = - 14 \\ v = 10 - 1 = 9\end{matrix}$$

Then, the significance level a is selected, generally (0.05, 0.01, 0.1), and in consideration of preciseness, usually a=0.01. Then, 2.821 is obtained by referring to the data corresponding to one-sided P (1) in Table 1. Since |t|>2.821, it is considered that the average value of the measured value of the machine to-be-detected is greater than the average value of the measured value of the comparison machine, that is, the machine to-be-detected has a significant difference.

TABLE 1
t boundary value table

| | P(2): two-sided | | | | | | | |
|---|---|---|---|---|---|---|---|---|
| | 0.5 | 0.2 | 0.1 | 0.05 | 0.02 | 0.01 | 0.005 | 0.002 |
| | P(1): one-sided | | | | | | | |
| [symbol] | 0.25 | 0.1 | 0.05 | 0.025 | 0.01 | 0.005 | 0.0025 | 0.001 |
| 1 | 1 | 3.078 | 6.314 | 12.706 | 31.821 | 63.657 | 127.321 | 318.309 |
| 2 | 0.816 | 1.886 | 2.92 | 4.303 | 6.965 | 9.925 | 14.089 | 22.327 |
| 3 | 0.765 | 1.638 | 2.353 | 3.182 | 4.541 | 5.841 | 7.453 | 10.215 |
| 4 | 0.741 | 1.533 | 2.132 | 2.776 | 3.747 | 4.604 | 5.598 | 7.173 |
| 5 | 0.727 | 1.476 | 2.015 | 2.571 | 3.365 | 4.032 | 4.773 | 5.893 |
| 6 | 0.718 | 1.44 | 1.943 | 2.447 | 3.143 | 3.707 | 4.317 | 5.208 |
| 7 | 0.711 | 1.415 | 1.895 | 2.365 | 2.998 | 3.499 | 4.029 | 4.785 |
| 8 | 0.706 | 1.397 | 1.86 | 2.306 | 2.896 | 3.355 | 3.833 | 4.501 |
| 9 | 0.703 | 1.383 | 1.833 | 2.262 | 2.821 | 3.25 | 3.69 | 4.297 |
| 10 | 0.7 | 1.372 | 1.812 | 2.228 | 2.764 | 3.169 | 3.581 | 4.144 |
| 11 | 0.697 | 1.363 | 1.796 | 2.201 | 2.718 | 3.106 | 3.497 | 4.025 |
| 12 | 0.695 | 1.356 | 1.782 | 2.179 | 2.681 | 3.055 | 3.428 | 3.93 |
| 13 | 0.694 | 1.35 | 1.771 | 2.16 | 2.65 | 3.012 | 3.372 | 3.852 |
| 14 | 0.692 | 1.345 | 1.761 | 2.145 | 2.624 | 2.977 | 3.326 | 3.787 |
| 15 | 0.691 | 1.341 | 1.753 | 2.131 | 2.602 | 2.947 | 3.286 | 3.733 |
| 16 | 0.69 | 1.337 | 1.746 | 2.12 | 2.583 | 2.921 | 3.252 | 3.686 |
| 17 | 0.689 | 1.333 | 1.74 | 2.11 | 2.567 | 2.898 | 3.222 | 3.646 |
| 18 | 0.688 | 1.33 | 1.734 | 2.101 | 2.552 | 2.878 | 3.197 | 3.61 |
| 19 | 0.688 | 1.328 | 1.729 | 2.093 | 2.539 | 2.861 | 3.174 | 3.579 |
| 20 | 0.687 | 1.325 | 1.725 | 2.086 | 2.528 | 2.845 | 3.153 | 3.552 |
| 21 | 0.686 | 1.323 | 1.721 | 2.08 | 2.518 | 2.831 | 3.135 | 3.527 |

[symbol]

indicates data missing or illegible when filed

In step S150, marking each machine to-be-detected according to the statistical number of days when each machine to-be-detected has a significant difference.

In an exemplary embodiment, step S150 may include:

Step S1501, if the number of days on which a machine to-be-detected has a significant difference exceeds the predetermined ratio of the first predetermined number of days, marking a first mark on the machine to-be-detected;

Step S1502, if a machine to-be-detected only has a significant difference within the second predetermined number of days, marking a second mark on the machine to-be-detected.

As mentioned above, the first predetermined number of days may be 7 days, and the range of the predetermined ratio may be 70%˜90%, that is: if the machine to-be-detected has a significant difference for 5 to 6 days within a week, the first mark will be marked on the machine to-be-detected. Of course, the value range of the predetermined ratio can also be less than 70% or greater than 90%, which is not specifically limited here.

The second predetermined number of days may be 3 days, that is, if the machine to-be-detected only has a significant difference in the last 3 days within a week, the second mark will be marked on the machine to-be-detected. Of course, the second predetermined number of days may also be 2 days, 4 days, etc., and there is no special limitation here.

Therefore, the machine to-be-detected with the first mark actually performs worse than the machine to-be-detected with the second mark. Accordingly, the first mark may be “alarm”, and the second mark may be “warning”, so as to distinguish the operating conditions of the machine to-be-detected.

It should be noted that after marking each machine to-be-detected, the detection method of the embodiment of the present disclosure may further include:

notifying a marking result of each machine to-be-detected to a management staff of the wafer testing machines;, so that the management staff can master the specific conditions of the wafer testing machine and optimize the actual wafer production process accordingly.

For example, the detection status of the wafer testing machine can be periodically sent to the management staff by emails or scrolling screens, etc., which will not be described in detail here.

The embodiments of the present disclosure also provide a detection device of a wafer testing machine. The detection device may include a storage unit, a sifting unit, a distinguishing unit, a comparison unit, and a marking unit.

The storage unit is configured to store the original test data of the same batch of wafers tested by multiple wafer testing machines in multiple test items into the database; the sifting unit is configured to screen out target test data from the original test data in the database according to preset sifting conditions; the distinguishing unit is configured to perform statistics on the sifted target test data, to divide the multiple wafer testing machines into the comparison machine and a machine to-be-detected in each of the test items; the comparing unit is configured to compare whether there is a significant difference between the target test data of each machine to-be-detected and the target test data of the comparison machine, in a corresponding test item within the first predetermined number of days, and to perform statistics on the number of days when each of the machine to-be-detected has significant difference; the marking unit is configured to mark each machine to-be-detected according to the statistical number of days when each machine to-be-detected has a significant difference.

As mentioned above, after marking each machine to-be-detected, the marking results of each machine to-be-detected are notified to the management staff of the wafer testing machine. Correspondingly, the detection device may further include a notification unit for notifying the marking result of each machine to-be-detected to the management staff of the wafer testing machine.

For example, the notification unit can be a mail system, that is, the marking unit is connected to the mail system, and the detection status of the wafer testing machine is sent to the management staff by mail regularly, so that the management staff can grasp the specific status of the wafer testing machine and optimize the actual wafer production process accordingly.

The embodiments or implementations in this specification are described in a progressive manner, each embodiment focuses on the differences from other embodiments, and the same or similar parts between the various embodiments can be referred to each other.

In the description of this specification, the description referring to the terms “embodiment”, “exemplary embodiments”, “some embodiments”, “schematic implementation”, “sample” or the like means that the specific features, structures, materials or characteristics described in conjunction with this embodiment or example are included in at least one embodiment or example of the present invention.

In this specification, the schematic description of the above terms does not necessarily refer to the same embodiments or examples. Moreover, the described specific features, structures, materials or characteristics can be combined in an appropriate manner in any one or more embodiments or examples.

In the description of the present disclosure, it should be noted that the terms “central”, “up”, “down”, “left”, “right”, “vertical”, “horizontal”, “inner”, “outer”, etc. indicate the orientation or positional relationship based on the orientation or positional relationship shown in the drawings, it is only for the convenience of describing the present disclosure and simplifying the description. It does not indicate or imply that the pointed device or element must have a specific orientation, be configured and operated in a specific orientation, and therefore cannot be understood as a limitation of the present disclosure.

It can be understood that the terms “first”, “second”, etc. used in the present disclosure can be used in the present disclosure to describe various structures, but these structures are not limited by these terms. These terms are only used to distinguish the first structure from another structure.

In one or more drawings, the same elements are represented by similar reference numerals. For clarity, several parts of the attached drawings are not drawn to scale. In addition, some publicly known parts may not be shown. For simplicity, the structure obtained after several steps can be described in a single diagram. Many of the specific details of this disclosure, such as device structure, material, size, processing process, and technology, are described below for a clearer understanding of this disclosure. But as those skilled in the field can understand, this disclosure can be implemented without these specific details.

Finally, it should be noted that the above embodiments are only used to illustrate the technical solutions of the present disclosure, not to limit them; although the present disclosure has been described in detail with reference to the foregoing embodiments, those skilled in the art should understand: it can still modify the technical solutions described in the foregoing embodiments, or equivalently replace some or all of the technical features; However, these modifications or replacements do not cause the essence of the corresponding technical solutions to deviate from the scope of the technical solutions of the embodiments of the present disclosure.

### INDUSTRIAL APPLICABILITY

The embodiment of the present disclosure provides the detection method and the detection device of wafer testing machine. In the detection process, firstly, perform statistics on the target test data sifted from the original test data in the database according to the preset sifting conditions, and divide the multiple wafer testing machines into the comparison machines and the machines to-be-detected in each of the test items; the comparison machine is equivalent to the standard machine, that is, the comparison machine has no abnormal situation, and then the comparison machine is used as the standard to determine whether the machine to-be-detected has an abnormal situation. Next, compare whether there is significant difference between the target test data of each of the machine to-be-detected in a corresponding test item and the target test data of the comparison machine in the same test item within the first predetermined number of days. If the target test data of the machine to-be-detected has a significant difference, it means that the machine to-be-detected has an abnormal risk; if the target test data of the machine to-be-detected does not have a significant difference, it means that the machine to-be-detected is operating well. Finally, after performing statistics on the number of days when each machine to-be-detected has a significant difference, mark each machine to-be-detected according to the statistical number of days when each machine to-be-detected has a significant difference. Thus, according to the marking results of each machine to-be-detected, it can be judged which wafer testing machine has abnormal conditions. Since the detection method of the present disclosure can automatically complete the detection process of the wafer testing machine, the time consumption of the detection process is shortened. Furthermore, the detection method of the present disclosure screens out target test data from the original test data according to preset sifting conditions, so that the number of target test data used for statistics is larger, and the error of data analysis is reduced, and the accuracy of the detection result is improved.

1. A detection method of a wafer testing machine, comprising:
storing an original test data of a same batch of wafers tested by multiple wafer testing machines in multiple test items into a database;
sifting out target test data from the original test data in the database according to preset sifting conditions;
performing statistics on the target test data sifted; and dividing the multiple wafer testing machines into comparison machines and machines to-be-detected in each of the test items;
comparing whether there is significant difference between a target test data of each of the machine to-be-detected and a target test data of the comparison machine, in a corresponding test item within a first predetermined number of days; and performing statistics on number of days when each of the machines to-be-detected has significant difference; and
marking each of the machines to-be-detected, according to a statistical number of days when each machine to-be-detected has a significant difference.

2. The detection method according to claim 1, wherein marking each of the machines to-be-detected comprises:
marking a first mark on a machine to-be-detected, if number of days when the machine to-be-detected has a significant difference exceeds a predetermined ratio of a first predetermined number of days; or
marking a second mark on a machine to-be-detected, if the machine to-be-detected only has a significant difference within a second predetermined number of days.

3. The detection method according to claim 2, wherein the first mark is “alarm”, and the second mark is “warning”.

4. The detection method according to claim 2, wherein a range of the predetermined ratio is 70%˜90%.

5. The detection method according to claim 1, wherein, performing statistics on the target test data sifted; and dividing the multiple wafer testing machines into comparison machines and machines to-be-detected in each of the test items comprise:
sorting the wafer testing machines, according to a median of the target test data of each wafer testing machine; and taking 50% of the wafer testing machines in the middle as a stable group; and
dividing the multiple wafer testing machines into the comparison machines and the machines to-be-detected in each of the test items, according to an upper quartile and a lower quartile of the stable group.

6. The detection method according to claim 5, wherein sorting the wafer testing machines, according to the median of the target test data of each wafer testing machine comprises:
drawing a box plot corresponding to each wafer testing machine, according to the target test data sifted of each wafer testing machine; and
sorting medians in the box plots, to complete the sorting of the wafer testing machines.

7. The detection method according to claim 6, wherein, dividing the multiple wafer testing machines into the comparison machines and the machines to-be-detected in each of the test items, according to an upper quartile and a lower quartile of the stable group comprises:
taking a wafer testing machine as a machine to-be-detected, if the median of the box plot of the wafer testing machine is greater than the upper quartile;
taking a wafer testing machine as a comparison machine, if the median of the box plot of the wafer testing machine is greater than or equal to the lower quartile and less than or equal to the upper quartile; or
taking a wafer testing machine as a machine to-be-detected, if the median of the box plot of the wafer testing machine is less than the lower quartile.

8. The detection method according to claim 1, further comprising:
comparing whether there is a significant difference between a target test data of each machine to-be-detected and a target test data of the comparison machine within the first predetermined number of days by a t-test method.

9. The detection method according to claim 8, wherein the t-test method satisfies a first relation formula:
$$\{ \begin{matrix}t = \frac{\overline{x} - {μ}_{0}}{\frac{S}{\sqrt{n}}} \\ v = n - 1\end{matrix} ;$$
wherein, x̅ is an average value of the target test data of the comparison machines; μ₀ is an average value of the target test data of the machines to-be-detected; v is a degree of freedom; n is number of the target test data of the comparison machines;
S is a standard deviation of the target test data of the comparison machines, and S satisfies a second relation formula:
$$S = \sqrt{\frac{{\sum }_{i = 1}^{n} {( {x}_{i} - \overline{x} )}^{2}}{n}} ;$$
wherein, xᵢ is the target test data of the comparison machine in the first predetermined number of days.

10. The detection method according to claim 1, wherein after marking each machine to-be-detected, the detection method further comprises:
notifying a marking result of each machine to-be-detected to a management staff of the wafer testing machines.

11. A detection device of a wafer testing machine, comprising:
a storage unit, configured to store an original test data of a same batch of wafers tested by multiple wafer testing machines in multiple test items into a database;
a sifting unit, configured to screen out target test data from the original test data in the database according to preset sifting conditions;
a distinguishing unit, configured to perform statistics on the target test data sifted, to divide the multiple wafer testing machines into comparison machines and machines to-be-detected in each of the test items;
a comparing unit, configured to compare whether there is a significant difference between a target test data of each machine to-be-detected and a target test data of the comparison machine, in a corresponding test item within a first predetermined number of days, and to perform statistics on number of days when each of the machine to-be-detected has significant difference; and
a marking unit, configured to mark each of the machines to-be-detected according to a statistical number of days when each machine to-be-detected has a significant difference.

12. The detection device according to claim 11, further comprising:
a notification unit, configured to notify a marking result of each machine to-be-detected to a management staff of the wafer testing machines.
